(19) United States
(12) Patent Application Publication
(10) Pub. No.: US 2026/0178579 A1
(43) Pub. Date: Jun. 25, 2026

(54) MODEL DISCOVERY ENGINE FOR MACHINE-LEARNING MODELS DEPLOYED BY DATA PROCESSING SERVICE

(71) Applicant: Databricks, Inc., San Francisco, CA (US)

(72) Inventor: Ayushi Batwara, Sammamish, WA (US)

(21) Appl. No.: 18/991,864

(22) Filed: Dec. 23, 2024

(51) Int. Cl. G06F 16/2453; G06F 16/242

(52) U.S. Cl. CPC G06F 16/24539; G06F 16/2438

(57) ABSTRACT

A semantic search between a vector embedding of a sample query and vector embeddings of plural historical queries is performed to identify a predetermined number of historical queries that best match the sample query. A model discovery database stores, for each of plural large language models (LLMs) and for each of the plural historical queries, a historical response to the historical query received from the LLM, associated metadata, and a quality rank. For each of the LLMs, a score for each of plural predetermined metrics is determined based on the quality rank of the LLM and the associated metadata in the model discovery database for the identified predetermined number of historical queries. For each of the plural LLMs, an overall score of the LLM is determined based on the determined scores for the plural predetermined metrics. A ranked list of the LLMs is generated based on the overall scores.

### TECHNICAL FIELD

This disclosure relates generally to model serving systems, and more specifically to, automatically recommending models and configuring serving endpoints of the model serving system.

### BACKGROUND

Consumption of Software as a Service (SaaS) applications has increased considerably. With growing demands to leverage advanced technologies like AI (Artificial Intelligence), such applications often rely on Large Language Models (LLMs) to fulfill a myriad of customer needs ranging from generating text, translating content, answering questions, etc. These LLMs are typically deployed and interfaced through specific model serving endpoints.

While LLMs have proven to be effective in numerous contexts, one constant challenge is the selection and configuration of the right model that fits individual user's unique use-cases. The great multitude of AI models, each with varying strengths and capabilities, combined with the complexities of their settings, make this selection process a laborious task. This is more so when it's regarded that customers of a SaaS system might not possess the technical knowledge nor the expertise to determine the ideal model for their needs. Also, hosting and serving too many models may lead to unnecessary consumption of valuable computing resources and network bandwidth. A better, automated system for identifying and configuring serving endpoints is desirable.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

Figure (FIG. 1 is a high-level block diagram of a system environment for a data processing service, in accordance with one or more embodiments.

FIG. 2 illustrates a block diagram of an architecture of a control layer of the data processing service, in accordance with one or more embodiments.

FIG. 3 is a block diagram of a model discovery engine of the control layer, in accordance with one or more embodiments.

FIG. 4 is a block diagram illustrating a process of generating historical data for a model discovery database, in accordance with one or more embodiments.

FIG. 5 is a block diagram illustrating a process of generating a ranked list of models based on a sample query, in accordance with one or more embodiments.

FIG. 6 is an example illustration of a graphical user interface for an application operator to create and configure a model serving endpoint, in accordance with one or more embodiments.

FIG. 7 is an example illustration of a graphical user interface for an application operator to input a sample query for generating a ranked list of models, in accordance with one or more embodiments.

FIG. 8 is an example illustration of a graphical user interface for an application operator to select one or more models from a ranked list of recommended models to create and configure a serving endpoint, in accordance with one or more embodiments.

FIG. 9 illustrates a method for generating a ranked list of models based on a sample query, in accordance with one or more embodiments.

FIG. 10 is a high-level block diagram of an exemplary machine to read and execute computer readable instructions, in accordance with one or more embodiments.

### DETAILED DESCRIPTION

The figures depict various embodiments of the present configuration for purposes of illustration only. One skilled in the art will readily recognize from the following discussion that alternative embodiments of the structures and methods illustrated herein may be employed without departing from the principles of the configuration described herein.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Over View

Conventionally, an application operator has to select a provider and a specific model of the provider and provide the configuration details for each selected model to which end user queries may be routed for different use cases such as automated chat bots, text generation, translation, and the like. This means the application operator must know which model to select from a list of available models for a given use case and then know how best to configure the model from the serving endpoint. This approach discourages application operators from discovering new models that may be better suited for a given use case. Also, sometimes the application operator may not know what the possible use cases are and so may be unable to select the right model for the endpoint. That is, the application operator may not know the right model to use and may not try to experiment and use different models that might be better suited for their requirements, e.g. latency, cost, availability, output, quality, price-performance, etc. This could lead to an inferior user experience and suboptimal adoption of external models.

To overcome the above problems, this disclosure pertains to using AI to automate model discovery and configuration on serving endpoints. Techniques disclosed herein look to provide a vendor-agnostic abstraction for common LLM use cases and allow application operators to experiment with different vendor SaaS LLMs easily and securely without having to write vendor-specific code for each LLM they want to try. The systems and methods disclosed herein also allows the application operator to centralize credential management and monitor or control costs, latency and other model serving metrics on an endpoint-basis.

The model discovery engine according to the present disclosure utilizes a model discovery database built using historical (e.g., empirical, actual historical, synthetic, experimental) end user queries and different external model outputs and associated metadata. The discovery engine may then automatically and intelligently identify one or more models that satisfy customer constraints and meet or exceed expectations without the application operator having to specify a model provider or a specific model. The application operator can simply input a sample query and the engine can recommend the model(s) based on the information stored in the model discovery database. More specifically, when the user uses the model discovery engine, the user simply specifies the sample query(s) that they intend on directing to the endpoint. In order to make the most informed decision about which model they should use, the engine curates relevant data from our the model discovery database and evaluates which models would be the best to use for the sample query. First, the engine embeds the user's sample queries and perform an embedding search over the model discovery database to retrieve the top k (e.g., k=200) records for each model. Then, for each model, the engine normalizes its rank, execution duration (e.g., latency in milliseconds), and cost columns. The engine then finds the mean for each and multiplies the sensitivity for each parameter (e.g., quality, cost, and latency sensitivities). Then, the engine obtains the percentile score for each metric using the standard normal distribution's cumulative distribution function. Finally, the engine generates an overall score by summing the percentile scores, which allows for stack-ranking the models. In parallel, the engine queries the corresponding models with the sample queries so that the user can immediately make a judgment on the sample outputs from each model. The engine displays the metrics and sample outputs in the user interface. In addition, as soon as the user selects a model from the recommended or ranked list, the engine automatically populates the configuration fields, including traffic routing percentages. As a result, the critical user journey is simplified, where customers can simply specify queries that they anticipate sending to the endpoint, and the engine would then create an endpoint that best meets customer needs.

### Example System Environment

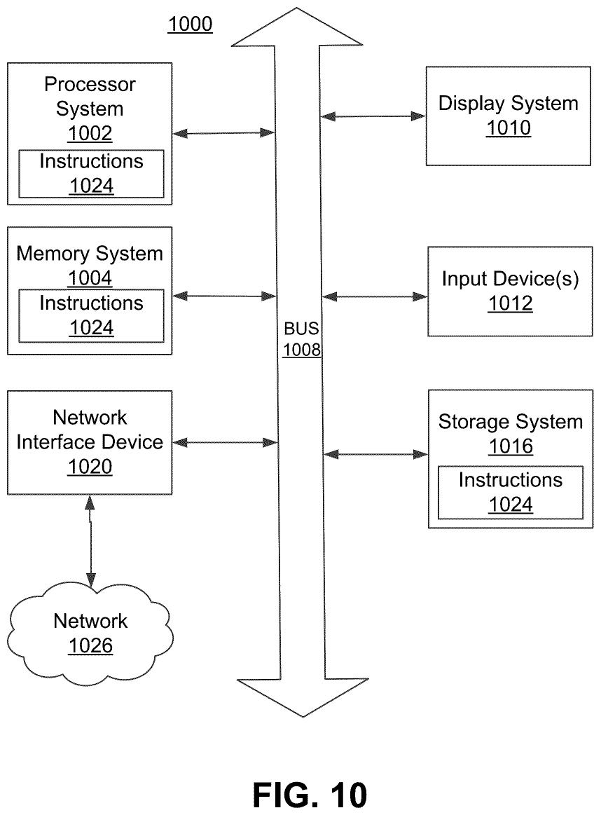

Figure (FIG. 1 is a high-level block diagram of a system environment 100 for a data processing service 102, in accordance with one or more embodiments. The system environment 100 shown by FIG. 1 includes application operators 101, a data processing service 102, a data storage system 110, one or more client devices 116, a model serving system 118, and a network 120. In alternative configurations, different and/or additional components may be included in the system environment 100. The computing systems of the system environment 100 may include some or all of the components (systems (or subsystems)) of a computer system 1000 as described in FIG. 10. In some embodiments, the computing devices may be configured with software to function as specifically described herein. For example, program code comprised of instructions may cause a processing system to be structured in a manner so that the device operates the specific functionality upon execution of the program code.

An application operator 101 is an entity that procures the services of the data processing service 102 to control and provide software applications or data and analytics to end users of the application operator. Backend functionality of the software applications or data of the application operator 101 may be provided by the data processing service 102. For example, a user (e.g., employee, customer, etc.) associated with the application operator 101 may interact with the data processing service 102 by using a client device 116. In some embodiments, the application operator 101 is an enterprise customer (e.g., a company providing products or services to customers) of the data processing service 102. FIG. 1 shows that the system environment 100 may include a plurality of application operators 101. Each application operator 101 may be an independent and unrelated entity, such as different unrelated businesses.

The data processing service 102 is a service for managing and coordinating data processing services (e.g., database services) for client devices 116 associated with application operators 101. The data processing service 102 may manage one or more applications that users of client devices 116 (e.g., agents of an application operator 101, end users or customers of an application operator) can use to communicate with the data processing service 102. Through an application of the data processing service 102, the data processing service 102 may receive requests (e.g., database queries, LLM queries) from users of client devices 116 to perform one or more data processing functionalities on data stored, for example, in the data storage system 110. In one embodiment, the requests may include machine learning and artificial intelligence (AI) related requests on data stored by the data storage system 110. The data processing service 102 may provide responses to the requests to the users of the client devices 116 after they have been processed.

In one or more embodiments, as shown in the system environment 100 of FIG. 1, the data processing service 102 includes a control layer 106 and a data layer 108. The components of the data processing service 102 may be configured by one or more servers and/or a cloud infrastructure platform. In one or more embodiments, the control layer 106 receives data processing requests and coordinates with the data layer 108 to process the requests from client devices 116. The control layer 106 may schedule one or more jobs for a request or receive requests to execute one or more jobs from the user directly through a respective client device 116 associated with an application operator 101.

In one embodiment, the data layer 108 includes computing resources that execute one or more tasks or jobs received from the control layer 106. Accordingly, the data layer 108 may include compute resources for executing the jobs. In one instance, the clusters of computing resources are virtual machines or virtual data centers configured on a cloud infrastructure platform. In one instance, the control layer 106 is configured as a multi-tenant system and the data layers 108 of different tenants are isolated from each other. For example, the data layers 108 of different application operators 101 may be isolated from each other.

In one instance, a serverless implementation of the data layer 108 may be configured as a multi-tenant system with strong virtual machine (VM) level tenant isolation between the different tenants of the data processing service 102. Each customer (e.g., application operator 101) represents a tenant of a multi-tenant system and shares software applications and also resources such as databases of the multi-tenant system. Each tenant's data is isolated and remains invisible to other tenants. For example, a respective data layer instance can be implemented for a respective tenant. However, it is appreciated that in other embodiments, single tenant architectures may be used.

The data layer 108 thus may be accessed by, for example, a developer through an application of the control layer 106 to execute code developed by the developer. In one embodiment, the compute resources are configured with one or more hardware accelerators, such as graphic processor units (GPUs), tensor processor units (TPUs), neural processing units (NPUs) that can accelerate the training or inference process of large-scale machine learning models or AI models. Thus, the data layer 108 may include resources not available to a developer on a local development system, such as powerful computing resources to process very large data sets.

The data storage system 110 includes a device (e.g., a disc drive, a hard drive, a semiconductor memory) used for storing database data (e.g., a stored data set, at least a portion of a stored data set, data for executing a query). The data storage system 110 may store data in the format of data tables, unstructured or structured data (e.g., enterprise data), and the like, that can be used to train or perform inference using the machine learning models described herein. For example, the data storage system 110 may store significant amounts of training data that can be used to train or fine tune parameters of machine learning models. In one embodiment, the data storage system 110 may also store trained models (e.g., parameters of the models, LLMs) that have been trained and fine-tuned by compute resources of the data processing service 102.

In one embodiment, the data storage system 110 includes a distributed storage system for storing data and may include a commercially provided distributed storage system service. Thus, the data storage system 110 may be managed by a separate entity than an entity that manages the data processing service 102, for example, a customer or user (e.g., application operator 101) of the data processing service 102. In another embodiment, the data storage system 110 may be managed by the same entity that manages the data processing service 102. Thus, coupled with the serverless implementation of compute resources of the data layer 108, the data processing service 102 may manage access controls to user data stored in the data storage system 110, maintenance tasks for the user data, and the like without separately configuring and deploying infrastructure.

The client devices 116 are computing devices that display information to users and communicate user actions to the various components of the system environment 100. Many client devices 116 corresponding to one or more application operators 101 may communicate with the various components of the system environment 100. In one or more embodiments, client devices 116 of the system environment 100 may include some or all of the components (systems (or subsystems)) of a computer system 1000 as described in FIG. 10.

In one embodiment, a client device 116 executes an application allowing a user of the client device 116 to interact with the various components of the system environment 100. For example, a client device 116 can execute a browser application to enable interaction between the client device 116 (and corresponding application operator 101) and the data processing service 102 via the network 120. In another embodiment, the client device 116 interacts with the various components of the system environment 100 through an application programming interface (API) running on a native operating system of the client device 116, such as IOS® or ANDROID™.

The model serving system 118 includes resources for deploying one or more machine learning models owned by or subscribed by an application operator 101. In one instance, the machine learning models are large-scale models (LLMs) with a significant number of weights or parameters. The models may be configured to perform natural language processing (NLP) tasks, audio processing tasks, image processing tasks, video processing tasks, and the like. For example, given a prompt, a model may generate a response or expand on the prompt in a human-like text. In one embodiment, the model serving system 118 receives input data (e.g., text data, audio data, image data, or video data) and encodes the input data into a set of input tokens. The model serving system 118 applies the machine learning model to generate the output data (e.g., text data, audio data, image data, or video data) including a set of output tokens.

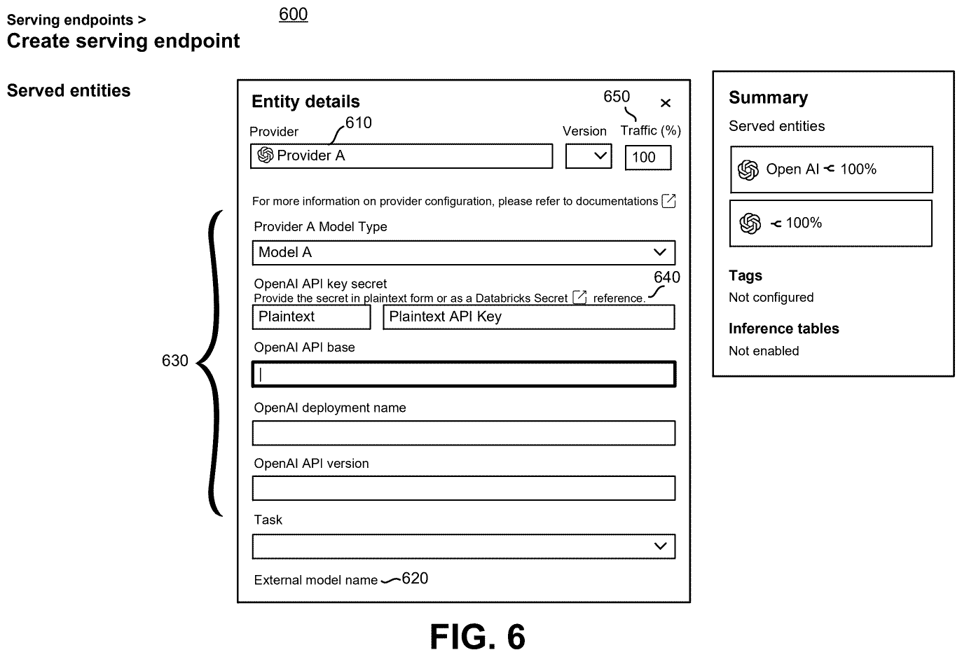

FIG. 1 illustrates the model serving system 118 as being a component of the system environment 100 that is separate from the data processing service 102 or the control layer 106. However, this may not necessarily be the case. In one or more embodiments, functionality of the model serving system 118 may be provided by components within the data processing service 102 or within the control layer 106. Also, the models served by the model serving system 118 may be foundational models hosted by the data processing service 102 and stored in the data layer 108 or in the data storage system 110. Alternately, or in addition, one or more of the models served by the model serving system 118 may be external models hosted and provided by external providers. The model serving system 118 may provide functionality to the application operator 101 to create and configure model serving endpoints (e.g., see FIG. 6). Once the model serving endpoint is created, the users or agents of the application operator 101 can utilize the endpoint to send queries to the associated one or more models and receive a response (e.g., natural language text) to their queries based on the output from the models.

In one embodiment, the machine learning models (e.g., external models, foundational models; i.e., any model servable by the model serving system 118) are configured as a transformer neural network architecture including one or more attention layers. However, it is appreciated that in other embodiments, the machine learning models can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the sequence of input or prompt tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large-scale models that are trained on a large corpus of training data (e.g., texts, images, audio, or video). For example, when the model is a large language model (LLM), the LLM may be trained on massive amounts of text data, often involving millions or billions of words or text units. The large amount of training data from various data sources allows the LLM to generate outputs for many inference tasks. A machine learning model may have a significant number of parameters in a deep neural network (e.g., transformer architecture), for example, at least 1 billion, at least 50 billion, at least 100 billion, at least 500 billion, at least 1 trillion, at least 2 trillion parameters.

Since the parameter size and the amount of computational power for training or performing inference on the machine learning models may be significantly high, in one embodiment, the model serving system 118 is configured with, for example, supercomputers that provide enhanced computing capability via one or more hardware accelerators, such as graphic processor units (GPUs), tensor processor units (TPUs), and/or neural processor units (NPUs). In one instance, the models may be trained and hosted on a cloud infrastructure service provided by the data processing service 102.

In one or more embodiments, the data generated when a query is input to a model served by the model serving system 118 may be stored in an inference table. The model serving system 118 may be configured to store in the inference table, metadata associated with the prompts or queries input to the models served by the model serving system 118. The inference table may be stored in the data layer 108 as tenant-level (i.e., application operator-level) data in isolation from inference table data of other tenants of the multi-tenant architecture.

The model serving system 118 may cause the inference table to automatically capture and log incoming requests and outgoing responses for a model serving endpoint. The data in this table may be used to monitor, debug, train and improve ML models. Inference tables simplify monitoring and diagnostics for models by continuously logging serving request inputs and responses (predictions) from model serving endpoints and saving them. Techniques such as SQL querying can then be performed to access the data logged in the inference tables. The data logged by the inference table for each query or prompt may include, e.g., the input or prompt tokens representing a tokenization of the user query that is input to the model, the output tokens representing the tokenized output from the model to the query, the natural language response to the user query (e.g., content) generated based on the output tokens, as well as additional information like execution duration (e.g., in milliseconds and representing the amount of time it took for the model to execute the query), timestamp, and other identifying or routing information.

The application operators 101, data processing service 102, data storage system 110, client devices 116, and model serving system 118 can communicate with each other via the network 120. The network 120 is a collection of computing devices that communicate via wired or wireless connections. The network 120 may include one or more local area networks (LANs) or one or more wide area networks (WANs). The network 120, as referred to herein, is an inclusive term that may refer to any or all of standard layers used to describe a physical or virtual network, such as the physical layer, the data link layer, the network layer, the transport layer, the session layer, the presentation layer, and the application layer. The network 120 may include physical or virtual media for communicating data from one computing device to another computing device, such as multi-protocol label switching (MPLS) lines, fiber optic cables, cellular connections (e.g., 3G, 4G, or 5G spectra), or satellites. The network 120 also may use networking protocols, such as TCP/IP, HTTP, SSH, SMS, or FTP, to transmit data between computing devices. In some embodiments, the network 120 may include Bluetooth or near-field communication (NFC) technologies or protocols for local communications between computing devices. The network 120 may transmit encrypted or unencrypted data.

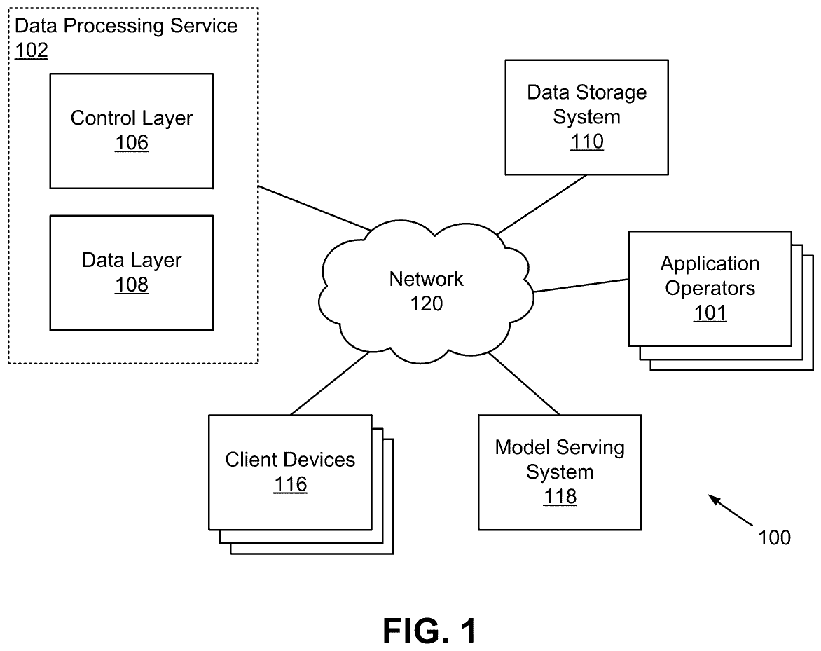

FIG. 2 is a block diagram of an architecture of a control layer 106, in accordance with one or more embodiments. In one embodiment, the control layer 106 includes a data management module 225, a training module 230, an inference module 235, an interface 240, and a model discovery engine 250. In alternative configurations, different and/or additional components may be included in the control layer 106. The computing systems of the control layer 106 may include some or all of the components (systems (or subsystems)) of a computer system 1000 as described in FIG. 10.

The data management module 225 generates and manages the training datasets for training one or more machine learning models that are to be deployed on the model serving system 118 and/or on other systems by the data processing service 102. In one instance, the training dataset may be stored or is constructed from data (e.g., enterprise data associated with a particular application operator 101) stored in the data storage system 110. In one embodiment, for a given model to be trained, the data management module 225 obtains a training dataset including a set of training instances.

In one or more embodiments, as the machine learning models are deployed and users perform inference using the machine learning models, the data management module 225 may obtain feedback from users with respect to the outputs that were generated by the machine learning models during the inference process. In this case, the data management module 225 determines whether the feedback is positive or negative, and the data management module 225 may update the training dataset to include training instances where the outputs were known to have positive feedback from the user. The updated training dataset may then be used to fine-tune parameters of the machine learning models.

The training module 230 instructs and coordinates training of one or more machine learning models (e.g., foundational LLMs hosted by the data layer 108 or the data storage system 110). In one or more embodiments, the training module 230 coordinates training on compute resources of the data layer 108 that are configured with multiple hardware accelerators to accelerate the training process of large-scale models. In one or more embodiments, the training module 230 trains the model by instructing compute resources to repeatedly iterate between a forward pass step and a backpropagation step to reduce a loss function. The forward pass includes a pass through the model. The training module 230 may perform the forward pass for a batch of training instances. A batch includes a set of data points (e.g., 16-32 data points).

In the forward pass step, the training module 230 applies parameters of the model to inputs to generate estimated outputs. The training module 230 determines a loss function. The loss indicates the difference between the estimated outputs and the known outputs in the training data for the training instance. In the backpropagation step, the training module 230 updates the parameters of the model based on terms from the loss function. The training module 230 may iterate the forward pass and backpropagation steps for multiple batches of training for a set number of epochs (e.g., three epochs) or until a convergence criterion is reached (e.g., change in loss between iteration is less than a threshold change). The training module 230 may store the trained parameters of the model in a dedicated datastore.

The inference module 235 may obtain one or more trained machine learning models and manage processing requests for inference using the trained model. In one or more embodiments, a trained model is deployed on the model serving system 118 using one or more model serving endpoints. The inference module 235 may configure and manage interfaces such as application programming interface (APIs) or gRPC interfaces, so that users can submit requests to the interface. The requests may include inputs and the model may be applied to the inputs to generate outputs. The outputs are provided back to the users as a response to the request.

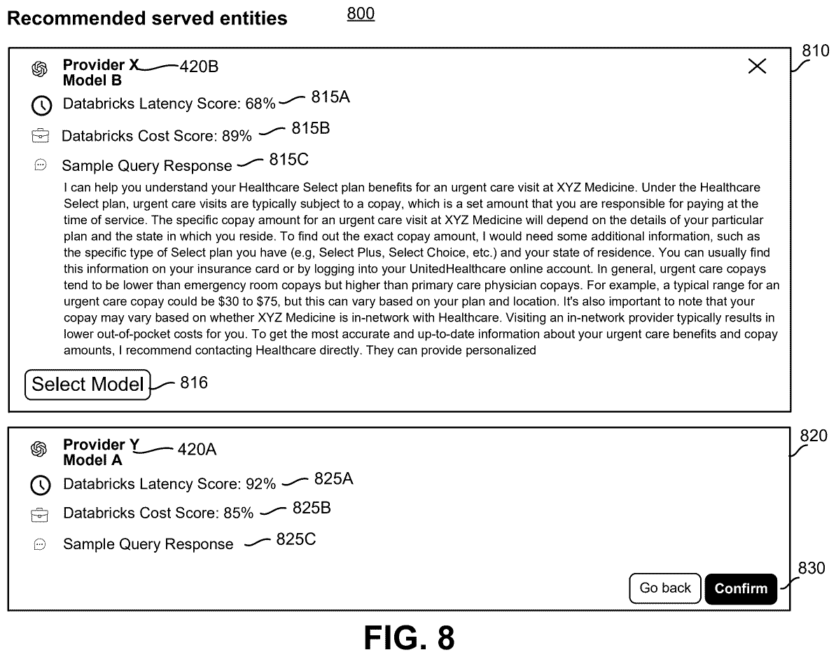

The interface 240 orchestrates interactivity between application operators 101 operating the client devices 116 and one or more applications of the control layer 106. In one or more embodiments, the interface 240 includes a graphical user interface (e.g., FIGS. 6-8) for a user of the client device 116 (e.g., an agent of an application operator 101) and/or a third-party software platform to interact with the control layer 106. For example, the interface 240 enables the user to interact with a user interface (e.g., FIG. 6) to create a model serving endpoint to enable a particular functionality (e.g., chatbot, text generation, and the like) for end users (e.g., customers) of the application operator 101. As another example, the interface 240 enables the model discovery engine 250 to interact with a user interface (e.g., FIG. 8) to present a ranked list of recommended models and corresponding metrics and sample query responses in response to a sample query provided by the user.

The interface 240 may be a web application that is run by a web browser at a user device (e.g., client device 116) or a software as a service platform that is accessible by the client device 116 through the network 120. The interface may be the front-end component of a mobile application or a desktop application. In one or more embodiments, the interface may use application program interfaces (APIs) to communicate with user devices or third-party platform servers, which may include mechanisms such as webhooks.

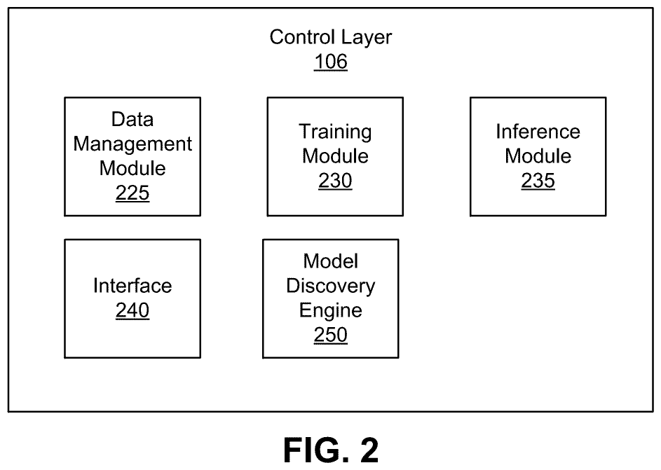

The model discovery engine 250 enables application operators 101 to discover new models that are best suited for specific user cases based on sample user queries and automatically configure model serving endpoints to route query traffic to the discovered models. Architecture, including backend components, frontend interfaces, and functional features, of the model discovery engine 250 is explained in more detail below in connection with FIGS. 3-9.

### Example Model Discovery Engine and Graphical User Interfaces

FIG. 3 is a block diagram of a model discovery engine 250 of the control layer 106, in accordance with one or more embodiments. FIG. 3 shows that the model discovery engine 250 includes a model discovery database 310, an embedding module 320, a semantic searching module 330, a retrieval module 340, a metric scoring module 350, a model ranking module 360, a model serving endpoint configuration module 370, and a traffic routing module 380. In alternative configurations, the model discovery engine 250 includes different and/or additional components and the functionality of the components may be distributed in a different manner.

The model discovery database 310 stores empirical data (e.g., historical data, synthetic data, manually generated data) associated with user queries used by the model discovery engine 250 to identify and recommend or rank the best models for an application operator 101 based on sample queries provided by the application operator 101. The empirical data stored in the model discovery database 310 may be associated with or specific to one or more trained or fine-tuned customized models of a particular application operator 101 for whom the model discovery engine 250 is to recommend models based on new sample queries. In other embodiments, the empirical data may be more generic and used across application operators 101 and/or model use cases. Using the empirical data that is limited to the custom trained and fine-tuned models of a particular application operator 101 may have the added advantage that the model recommendations or rankings made using such empirical data will be highly accurate and customized to the use cases encountered by the particular application operator 101. This will also have reduced impact on the application operator 101 since the recommended models by the discovery engine 250 will be models the application operator 101 has already trained or fine-tuned and has access to.

In one or more embodiments, the empirical data may be data associated with past or historical queries that have been received by the inference module 235 to submit as prompts to trained machine learning models deployed on the data layer 108, the data storage system 110, or by an external system, all of which may be served by the model serving system 118. Alternately, or in addition, the empirical data stored in the model discovery database 310 may include the labeled training data stored by the training module 230 and used to train one or more of the models served by the model serving system 118. Alternately, or in addition, the empirical data may include synthetic data (e.g., synthetically generated queries) generated by another machine-learned model based on input samples. Alternately, or in addition, the empirical data may be manually generated.

The empirical data may include data for each of a plurality of LLMs the model discovery engine 250 is designed to recommend. For example, the model discovery engine 250 may be designed to recommend one or more models or generate a ranked list of models out of a predetermined number of models and model providers for which empirical data is available in the model discovery database 310.

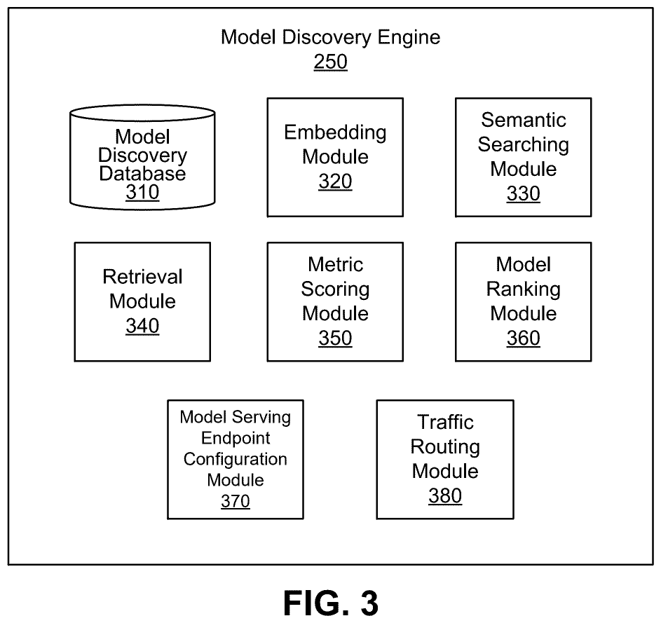

The process of creating the empirical data or historical data for the model discovery database 310 is described in further detail below in connection with FIG. 4. FIG. 4 shows that the historical query 410 is an query from a user. However, as explained above, the query may be a synthetic query or a manually input query written for creating the model discovery database 310.

The empirical data may be created by running the historical (e.g., empirical, synthetic, user generated) queries through each of the plurality of LLMs and storing associated data. For example, the control layer 106 of the data processing service 102 may sequentially access the historical queries and the model serving system 118 may be operable to tokenize the queries and input the tokens into each LLM for which the empirical data is to be generated. Further, the model serving system 118 may also receive output tokens from the LLM in response to the input and cause the inference table to store metadata associated with the historical query, as well as the actual response to the query generated based on the output tokens.

In the example of FIG. 4, each historical query 410 is input by the serving endpoint of the model serving system 118 to three LLMs, Model A 420A, Model B 420B, and Model C 420C. While FIG. 4 illustrates three example models, in practice, any appropriate number of models may be used to obtain the data for the queries.

Thus, for each of the three LLMs 420A-420C and for each historical query 410, the empirical data stored in the model discovery database 310 (including in the inference tables) may include the historical (e.g., empirical, synthetic, user generated) query 410, the historical response 430 (430A-430C) to the historical query received from the associated LLM 420 (420A-420C), and associated metadata (440A-440C). FIG. 4 further illustrates that the associated metadata 440 stored in the model discovery database 310 for each (query 410, model 420) pair may include the request or the query 410 in natural language form, historical query execution duration or latency, input tokens or prompt tokens, output tokens, content or historical response in natural language form generated by the model serving system 118 based on the output tokens, timestamp, and other information automatically recorded in the inference table based on execution of the query 410 by the LLM 420.

Based on the information in the inference table, the model serving system 118 may also generate additional metrics or parameters for each (query 410, LLM 420) pair such as cost, quality rank, and the like, and store the parameters in the model discovery database 310. For example, the model serving system 118 may determine the cost associated with each historical query 410 based on associated prompt tokens 440 and output tokens 440 and corresponding publicly available information. Further, for each historical query, the model serving system 118 may determine a quality rank for each of the LLMs the query is input to. In the example of FIG. 4, for each query 410, the model serving system 118 may rank Models 420A, 420B, and 420C, based on the response 430A-430C output of the Models 420A-420C. For example, the model serving system 118 may evaluate the quality of the responses using a known library (e.g., MLFLOW library for LLM Model Evaluation) to generate a quality ranking 470 for each (model 420, query 410) pair. Using the library, the historical response 430 to the historical query 410 for each LLM 420 may be compared to a ground-truth response to the historical query 410 output from a ground-truth model (e.g., CLAUDE-3 OPUS model) and the quality rank 470 determined based on the comparisons. Each model's 420 identity may be concealed during the comparison to prevent unintended model bias from the ground-truth model. The results of the comparisons may be stored in a Delta Lake table and the quality rankings 470 may be stored in the model discovery database 310 in association with each (query 410, model 420) pair.

The data generation process to create the model discovery database 310 may be performed offline prior to enabling the functionality provided by the model discovery engine 250 to enable agents of application operators 101 to easily and quickly configure model serving endpoints to serve models that have been recommended based on sample queries by the model discovery engine 250. To create robust recommendations for customers, the model discovery database 310 may include many historical queries 410 and related empirical data across potential customer queries. That is, the number of historical queries 410 for which the data generation described above in connection with FIG. 4 is performed may be large. For example, the number of historical queries 410 may be in the order of hundreds or thousands or more.

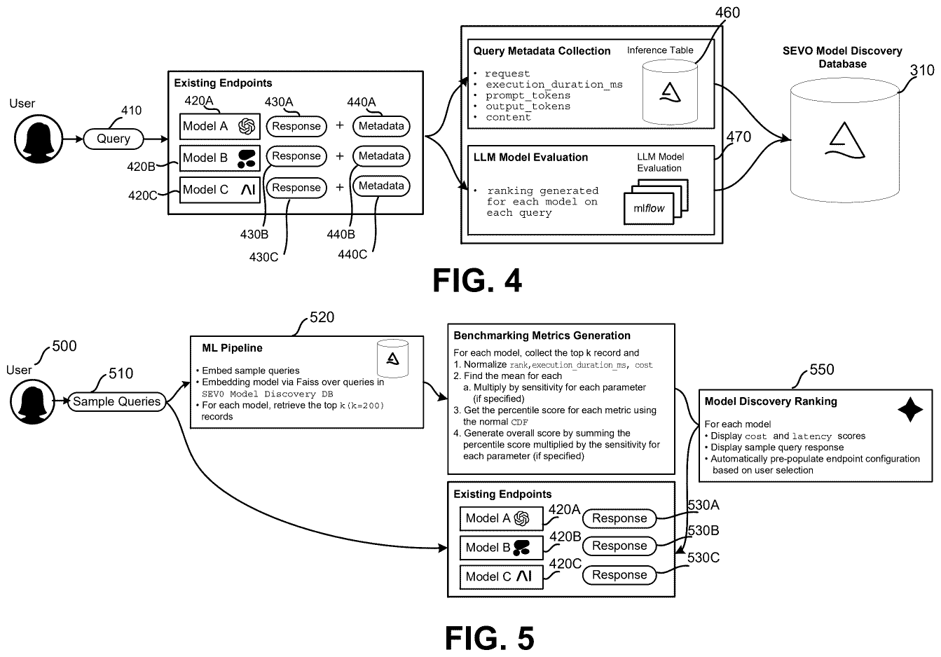

After the data generation process to create the model discovery database 310 has been completed, the model discovery engine 250 may be operable to recommend LLMs to application operators 101 based on sample queries. The process of recommending an LLM to an application operator 101 is described below in conjunction with FIGS. 3 and 5.

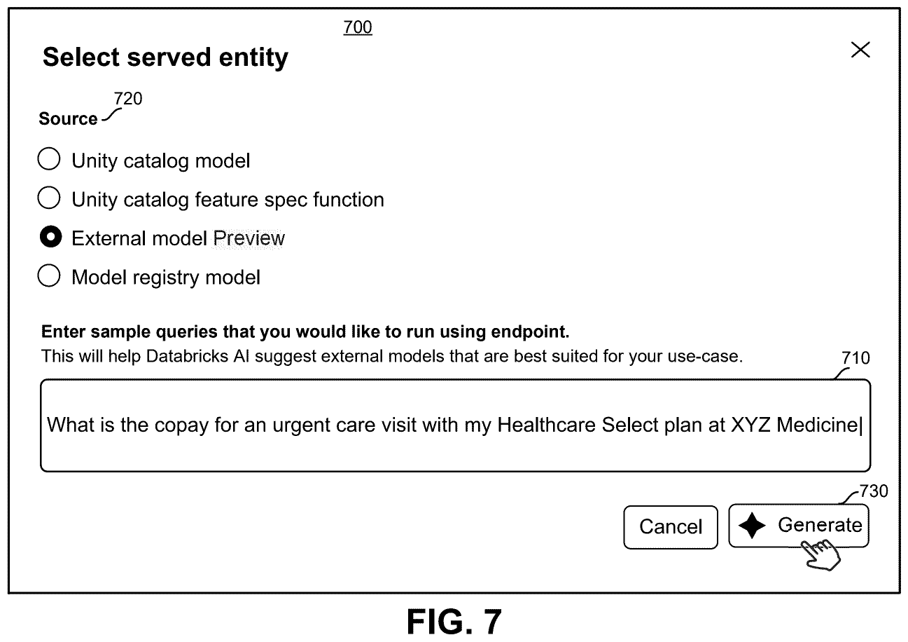

FIG. 5 shows that an agent 500 of an application operator 101 interacts with a user interface (e.g., FIGS. 6-7) of the model serving system 118 to create a model serving endpoint. The agent 500 may input one or more user queries 510 into the user interface. The querie(s) may represent a sample of the type of queries the agent 500 is looking to input into a LLM for a particular use-case. As explained previously, the LLM may be an LLM known to the agent 500 and hosted by the data layer 108 instance of the application operator 101 or hosted by the data storage system 110 of the application operator 101. Alternately, or in addition, the LLM may be an LLM that is external to the system environment 100 and that is accessible by the model serving system 118 but unknown to the agent of the application operator 101 as being a good or better LLM for the type of queries represented by the sample query 510.

In FIG. 3, the embedding module 320 may tokenize the received query(s) and generate a vector embedding of the query(s) input by the user via the user interface to create a model serving endpoint. The semantic searching module 330 may perform a semantic search between the vector embedding of the sample query input by the agent of the application operator 101 and vector embeddings of the plurality of historical queries stored in the model discovery database 310 to identify a predetermined number of the plurality of historical queries in the model discovery database 310 that best match the received query 510. As shown in FIG. 5, the sample query 510 is input to an ML pipeline 520 that embeds the sample query 510 and performs the semantic search (e.g., embedding search). The framework creates a data structure called an index that allows searching for and finding embeddings that are similar to an input embedding.

Using the framework, a vector embedding of the sample query 510 input by the agent of the application operator 101 may be determined to be similar to one or more vector embeddings of the plurality of historical queries stored in the model discovery database 310 based on a cosine similarity of the embeddings being higher than a threshold. In one or more embodiments, the semantic searching module 330 is configured to identify a predetermined number of the plurality of historical queries in the model discovery database 310 that best match the received sample query 510. For example, the historical queries in the model discovery database 310 may be ranked in descending order based on their cosine similarity with the vector embedding of the sample query 510 and the top n number of historical queries having the highest cosine similarity may be identified as the predetermined number of the historical queries. In the example illustrated in FIG. 5, the top k (k=200) historical queries in the model discovery database 310 are identified by the semantic searching module 330.

The retrieval module 340 may retrieve the empirical data associated with the identified predetermined number of queries from the model discovery database 310 for each LLM. In the example of FIGS. 4-5, the model discovery database 310 stores the empirical data of three LLMs 420A, 420B, and 420C. Thus, the retrieval module 340 may extract the empirical data 430, 440 associated with the 600 (query, LLM) pairs associated with the 200 historical queries identified by the semantic searching module 330, and for each of the three models 420A, 420B, and 420C, for which data is available in the model discovery database 310.

The metric scoring module 350 determines scores for predetermined metrics for each of the LLMs the recommendation engine 250 is designed to recommend, based on the empirical data for the corresponding LLM retrieved by the retrieval module 340. That is, in the example of FIG. 5, the metric scoring module 350 may perform an iterative process for each of the LLMs, based on the corresponding retrieved 200 empirical data records determined to be similar to the sample input query 510 by the semantic searching module 330. More specifically, for each LLM, the metric scoring module 350 may determine a score for each of a plurality of predetermined metrics based on the quality rank of the LLM and the associated metadata in the model discovery database 310 for the identified predetermined number of the historical queries.

The predetermined metrics may include cost, latency, rank, and the like. In one or more embodiments, the metric scoring module may determine the scores of the predetermined metrics for each LLM by normalizing based on the quality ranks and the associated metadata in the model discovery database 310 for the predetermined number of the historical queries for the LLM retrieved by the retrieval module 340. In the example shown in FIGS. 4-5, for each of the models 420A, 420B, and 420C, the retrieval module 350 retrieves the corresponding top 200 similar historical queries and associated metadata from the model discovery database 310. Then, for the cost metric, the metric scoring module 200 may determine a normalized cost score for the LLM (e.g., Model A) based on the cost score stored as metadata 440 in the model discovery database 310 for each of the 200 empirical data records associated with the Model A. Normalized cost metrics may be determined for Models B and C in a similar manner.

For the latency or execution duration metric, the metric scoring module 200 may determine a normalized latency score for the LLM (e.g., Model A) based on the execution duration stored as metadata 440 in the model discovery database 310 for each of the 200 retrieved empirical data records associated with Model A. Normalized latency metrics may be determined for Models B and C in a similar manner. For the quality rank metric, the metric scoring module 200 may determine a normalized rank score for the LLM (e.g., Model A) based on the quality ranks stored as metadata 440 in the model discovery database 310 for each of the 200 empirical data records associated with the Model A. Normalized rank metrics may be determined for Models B and C in a similar manner.

In one or more embodiments, the metric scoring module 350 is configured to adjust weights of one or more of the predetermined metrics based on user specified sensitivity values for the one or more of the predetermined metrics. For example, the agent of the application operator 101 may specify by interacting with the user interface of the model discovery engine 250 that the quality of the query response is the main factor to be considered by the model discovery engine 250 when recommending and ranking models. As another example, the agent of the application operator 101 may specify by interacting with the user interface of the model discovery engine 250 that models with minimal latency should be ranked higher. By adjusting (e.g., increasing, decreasing) sensitivity values (e.g., by moving a sliding scroll bar on an interface) for each metric (e.g., cost, latency, quality, or rank), the application operator 101 may further personalize the recommendations they may receive by operation of the model discovery engine 250. Thus, as illustrated in FIG. 5, the normalized scores for each metric (e.g., rank, execution duration or latency, cost) may be adjusted by multiplying the mean score by the sensitivity value specified by the customer. If no sensitivity values are specified, each metric score may be multiplied by 1, thereby giving equal weights to all the predetermined metrics.

FIG. 5 further illustrates that percentile scores are obtained for each of the predetermined metrics using the normal cumulative distribution function. The result or output of the metric scoring module 350 is, for each of the LLMs being ranked, a normalized or percentile score for each of the metrics such as a cost score, a quality rank score, and a latency score, as well as the weights (e.g., a value between 0 and 1) for each of the metrics, based on the user specified sensitivity values, with the default value being 1 (e.g., when no sensitivity values are specified).

Next, the model ranking module 360 may determine, for each of the plurality of LLMs, an overall score of the LLM based on the determined scores for the plurality of predetermined metrics. For example, the model ranking module 360 may determining the overall score of the LLM based on the weighted scores of each of the predetermined metrics. In the example of FIGS. 4-5, the model ranking module 360 may generate for each of the models 420A, 420B, and 420C, an overall score by multiplying the percentile scores or normalized scores for each of the metrics by the corresponding weight value and then summing the weighted scores.

The model ranking module 360 ranks the various models (e.g., three models 420A-C in FIGS. 4-5) based on their overall scores, with, e.g., the model having the highest overall score being ranked first, the next highest overall scoring model being ranked second, and so on. Determining the overall score for each model, which score accounts for the user specified sensitivity values for the different parameters such as cost, quality, latency, allows the model discovery engine 250 to stack-rank the models in one list and easily present the ranked list to the user. The model ranking module 360 may orchestrate interactivity with the interface 240 to transmit to a user interface of a client device (e.g., FIG. 8), a ranked list of the plurality of LLMs based on the overall scores.

FIG. 5 further illustrates that the model discovery engine 250 may interact with the model serving system 118 to input the received query 510 to each of the plurality of LLMs (e.g., models 420A, 420B, 420C) to generate a corresponding sample response 530A, 530B, 530C, to the query 510. The model ranking module 360 may then orchestrate interactivity with the interface 240 to present the ranked list 550 of the plurality of LLMs via the user interface (e.g., FIG. 8) to the agent of the application operator 101. The ranked list 550 may include, for each LLM, the determined score for one or more of the plurality of predetermined metrics (e.g., corresponding scores for cost, latency, rank) and the corresponding sample response 530 generated by the LLM.

FIG. 6 is an example illustration of a graphical user interface 600 for an application operator 101 to create and configure a model serving endpoint, in accordance with one or more embodiments. The GUI 600 may represent the front-end of the interface 240 that is presented on the client device 116 associated with the application operator 101. The GUI 600 in FIG. 6 is the front-end of a conventional system where the agent of the application operator 101 has to manually select a provider 610 (e.g., Provider A in FIG. 6) and a particular model 620 of the provider 610. Further, the application operator 101 has to provide the specific configuration details 630 including the API key 640 for the selected provider 610 and model 620. After creating the endpoint, the model serving system 118 may then start routing queries received from the users of the application operator 101 to the configured endpoint. However, as explained previously, such a process requires the application operator 101 to first know which provider to select, select a particular model of the selected provider, and then provide the configuration details of the selected provider and the selected model. Such a process prevents the operator 101 from experimenting with or discovering new providers and models that may be selectable from the serving endpoint and that may be better suited for the types of queries the operator 101 intends to route to the endpoint.

To overcome these problems, the model discovery engine 250 according to the present disclosure provides backend functionality and frontend interfaces that abstract away the model selection and configuration process described in FIG. 6, and as shown in FIG. 7, provides a graphical user interface 700 that prompts the agent of the application operator 101 to simply input one or more sample queries in an interaction element 710 when creating a serving endpoint. As explained previously, the models recommendable by the engine 250 may be external models or custom or foundational models hosted by the application operator's 101 instance of the data layer 108 or the data storage system 110 of the application operator 101. The set of models from which the recommended models may be presented to the user may depend on the source 720 selected by the user when creating the new model serving endpoint. After providing the sample query via the interaction element 710, the agent of the application operator 101 may interact with interaction element 730 to generate the ranked list of LLMs based on the sample query.

FIG. 8 is an example illustration of a graphical user interface 800 for an application operator 101 to select one or more models from a ranked list of recommended models to create and configure a serving endpoint, in accordance with one or more embodiments. Continuing with the example illustrated in FIGS. 4-5, FIG. 8 shows that the model 420B has the highest overall score and is thus ranked first 810 in the ranked list of models, followed by model 420A ranked second 820, and so on. FIG. 8 further illustrates that the GUI 800 presents to the user, the weighted or normalized scores for each of the predetermined metrics 815A, 815B, 825A, 825B, such as cost and latency. FIG. 8 also illustrates that the GUI 800 presents to the user, the sample response 815C, 825C from the corresponding LLM for the sample query 510 provided by the agent of the application operator 101.

The agent can review the ranked list and quickly discern from the sample query response and corresponding metric scores which one or more models they wish to select for serving via the endpoint. After selecting one or more of the ranked models, the agent may interact with interaction element 830 to confirm their selection, causing the interface 240 to receive, from the user interface 800 of the client device, the selection of one or more of the LLMs from the ranked list (e.g., one or more of 810, 820, and so on).

FIG. 3 further shows that the model discovery engine 250 includes the model serving endpoint configuration module 370 and the traffic routing module 380. The model serving endpoint configuration module 370 may automatically configure the model serving endpoint being created by the agent in FIGS. 7-8 based on the selection received by the interface 240 from the user interacting with the GUI 800. In one or more embodiments, the model serving endpoint configuration module 370 may pre-store configuration data for different models of different providers, and automatically populate the configuration settings (e.g., settings 630 in FIG. 6) based on the model selected by the user from the ranked list of models in GUI 800. The user may then simply provide the secret API key (e.g., key 640 in FIG. 6) to complete configuring the creating the serving endpoint without knowing which model to select and what the configurations should be for the selected model.

The traffic routing module 380 may be configured to automatically determine traffic routing weights for each of two or more LLMs based on their respective overall scores, in response to determining that the selection received by the interface 240 from the user interacting with the GUI 800 includes a selection of two or more of the LLMs. The traffic routing module 380 may be configured such that a traffic routing weight of a first LLM having a first overall score is higher than a traffic routing weight of a second LLM having a second overall score, the first overall score being higher than the second overall score. In the example of FIGS. 4-5 and 8, say the overall percentile score of the first ranked model 420B (810) is 50% and the overall percentile score of the second ranked model 420A (820) is 40%, and the overall percentile score of the third ranked model (not shown) is 10%, and say the user interacts with the GUI 800 to select the first and third ranked models. In this example, the traffic routing module may assign traffic routing weights to the selected first and third ranked models based on their overall percentile scores. For example, the traffic routing weights may be 80% for the first selected model and 20% for the second selected model, based on their respective overall scores.

The model serving system 118 may use the set traffic routing weights to route user submitted queries to the respective models configured within the endpoint. Thus, in the above example, a new query received by the model serving system 118 may have an 80% probability of being routed to the first selected model in the model serving endpoint and may have a 20% probability of being routed to the second selected model in the model serving endpoint.

In one or more embodiments, the weights may be adjustable by the user. For example, after the user confirms the model selections from the ranked list of FIG. 8, and after the model serving endpoint configuration module 370 and the traffic routing module 380 configure the endpoint page with the appropriate settings and traffic routing weights for the selected models, the user may be able to interact with the GUI (e.g., GUI 600) to adjust the traffic percentage 650 for each selected and configured model. For example, the user may choose to route all traffic to one model or route traffic between two or more models equally.

### Example Methods

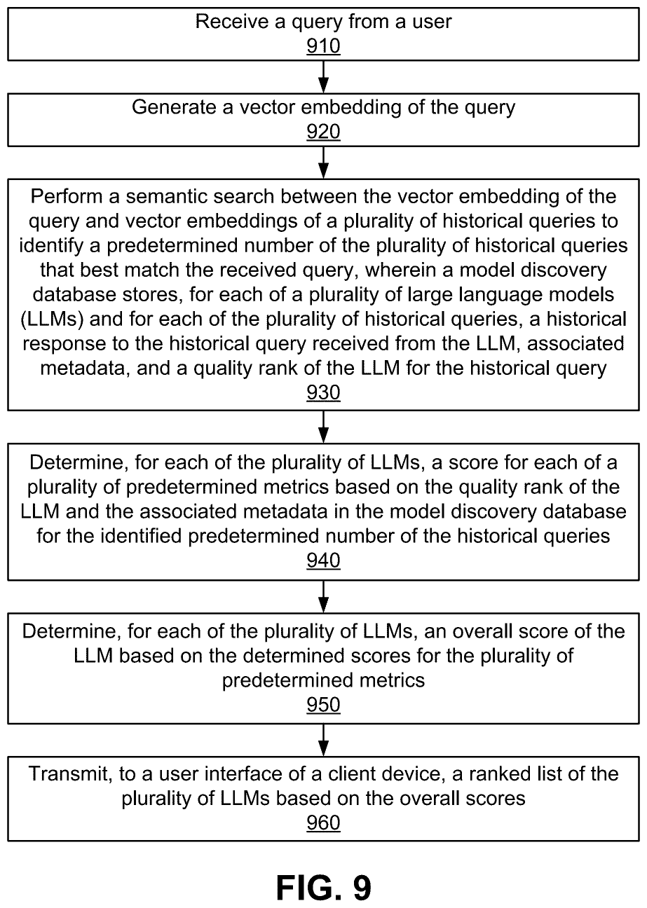

FIG. 9 illustrates a method 900 for generating a ranked list of models based on a sample query, in accordance with one or more embodiments. The process shown in FIG. 9 may be performed by one or more components (e.g., the control layer 106 or compute resources of the data layer 108) of a data processing system/service (e.g., the data processing service 102). Other entities may perform some or all of the steps in FIG. 9 (e.g., model discovery engine 250). The data processing service 102 as well as the other entities may include some or all of the components of the machine (e.g., computer system) described in conjunction with FIG. 10. Embodiments may include different and/or additional steps or perform the steps in different orders.

An interface (e.g., interface 240; GUI 700) may receive 910 a query from a user. The interface may receive multiple queries at block 910. The query(s) is a sample query based on which the agent of an application operator 101 wishes to create and configure a model serving endpoint for servicing queries of a similar type that are anticipated to be received from customers or users of the application operator 101.

An embedding module (e.g., embedding module 320) generates 920 a vector embedding of the query(s) received at block 910. A semantic searching module (e.g., semantic searching module 330) performs 930 a semantic search between the vector embedding of the query generated by the embedding module 320 and vector embeddings of a plurality of historical queries to identify a predetermined number (e.g., k=200 in FIG. 5) of the plurality of historical queries that best match the received query, wherein a model discovery database (e.g., database 310 in FIGS. 3-4) stores, for each of a plurality of LLMs (e.g., LLMs 420A, 420B, 420C in FIGS. 4-5) and for each of the plurality of historical queries, a historical response (e.g., 430A, 430B, 430C in FIG. 4) to the historical query received from the LLM, associated metadata (e.g., 440A, 440B, 440C in FIG. 4), and a quality rank (e.g., 470 in FIG. 4) of the LLM for the historical query.

A metric scoring module (e.g., metric scoring module 350 in FIG. 3) determines 940, for each of the plurality of LLMs (e.g., LLMs 420A, 420B, 420C in FIGS. 4-5), a score for each of a plurality of predetermined metrics (e.g., cost, latency, rank) based on the quality rank of the LLM and the associated metadata in the model discovery database 310 for the identified predetermined number of the historical queries (e.g., 200 historical queries and associated empirical data for each of models 420A, 420B, 420C in FIGS. 4-5).

A model ranking module (e.g., model ranking module 360) determines 950, for each of the plurality of LLMs (e.g., LLMs 420A, 420B, 420C in FIGS. 4-5), an overall score of the LLM based on the determined scores for the plurality of predetermined metrics.

An interface (e.g., interface 240) transmits 960, to a user interface (e.g., GUI 800 in FIG. 8) of a client device, a ranked list of the plurality of LLMs based on the overall scores.

### Example Machine to Read and Execute Computer Readable Instructions

Turning now to FIG. 10, illustrated is an example machine to read and execute computer readable instructions, in accordance with an embodiment. Specifically, FIG. 10 shows a diagrammatic representation of the data processing service 102 (and/or data processing system) in the example form of a computer system 1000. The computer system 1000 is structured and configured to operate through one or more other systems (or subsystems) as described herein. The computer system 1000 can be used to execute instructions 1024 (e.g., program code or software) for causing the machine (or some or all of the components thereof) to perform any one or more of the methodologies (or processes) described herein. In executing the instructions, the computer system 1000 operates in a specific manner as per the functionality described. The computer system 1000 may operate as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The computer system 1000 may be a server computer, a client computer, a personal computer (PC), a tablet PC, a smartphone, an internet of things (IoT) appliance, a network router, switch or bridge, or other machine capable of executing instructions 1024 (sequential or otherwise) that enable actions as set forth by the instructions 1024. Further, while only a single machine is illustrated, the term “machine” shall also be taken to include any collection of machines that individually or jointly execute instructions 1024 to perform any one or more of the methodologies discussed herein.

The example computer system 1000 includes a processing system 1002. The processor system 1002 includes one or more processors. The processor system 1002 may include, for example, a central processing unit (CPU), a graphics processing unit (GPU), a neural network processor (NPU), a tensor processing unit (TPU), a digital signal processor (DSP), a controller, a state machine, one or more application specific integrated circuits (ASICs), one or more radio-frequency integrated circuits (RFICs), or any combination of these. The processor system 1002 executes an operating system for the computing system 1000. The computer system 1000 also includes a memory system 1004. The memory system 1004 may include or more memories (e.g., dynamic random access memory (RAM), static RAM, cache memory). The computer system 1000 may include a storage system X16 that includes one or more machine readable storage devices (e.g., magnetic disk drive, optical disk drive, solid state memory disk drive).

The storage unit 1016 stores instructions 1024 (e.g., software) embodying any one or more of the methodologies or functions described herein. For example, the instructions 1024 may include instructions for implementing the functionalities of the enforcement platform 245 and/or the AI governance enforcement engine 315. The instructions 1024 may also reside, completely or at least partially, within the memory system 1004 or within the processing system 1002 (e.g., within a processor cache memory) during execution thereof by the computer system 1000, the main memory 1004 and the processor system 1002 also constituting machine-readable media. The instructions 1024 may be transmitted or received over a network 1026, such as the network 1026, via the network interface device 1020.

The storage system 1016 should be taken to include a single medium or multiple media (e.g., a centralized or distributed database, or associated caches and servers communicatively coupled through the network interface system 1020) able to store the instructions 1024. The term “machine-readable medium” shall also be taken to include any medium that is capable of storing instructions 1024 for execution by the machine and that cause the machine to perform any one or more of the methodologies disclosed herein. The term “machine-readable medium” includes, but not be limited to, data repositories in the form of solid-state memories, optical media, and magnetic media.

In addition, the computer system 1000 can include a display system 1010. The display system 1010 may driver firmware (or code) to enable rendering on one or more visual devices, e.g., drive a plasma display panel (PDP), a liquid crystal display (LCD), or a projector. The computer system 1000 also may include one or more input/output systems 1012. The input/output (IO) systems 1012 may include input devices (e.g., a keyboard, mouse (or trackpad), a pen (or stylus), microphone) or output devices (e.g., a speaker). The computer system 1000 also may include a network interface system 1020. The network interface system 1020 may include one or more network devices that are configured to communicate with an external network 1026. The external network 1026 may be a wired (e.g., ethernet) or wireless (e.g., WiFi, BLUETOOTH, near field communication (NFC).

The processor system 1002, the memory system 1004, the storage system 1016, the display system 1010, the IO systems 1012, and the network interface system 1020 are communicatively coupled via a computing bus 1008.

### ADDITIONAL CONSIDERATIONS

The foregoing description of the embodiments of the disclosed subject matter have been presented for the purpose of illustration; it is not intended to be exhaustive or to limit the disclosed embodiments to the precise forms disclosed. Persons skilled in the relevant art can appreciate that many modifications and variations are possible in light of the disclosed subject matter.

Some portions of this description describe various embodiments of the disclosed subject matter in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosed subject matter may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the present disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosed embodiments be limited not by this detailed description, but rather by any claims that issue on an application based hereon. Accordingly, the disclosure of the embodiments of the disclosed subject matter is intended to be illustrative, but not limiting, of the scope of the subject matter, which is set forth in the following claims.

1. A system, comprising:
one or more computer processors; and
one or more computer-readable mediums storing instructions that, when executed by the one or more computer processors, cause the system to:
receive a query from a user;
generate a vector embedding of the query;
perform a semantic search between the vector embedding of the query and vector embeddings of each of a plurality of historical queries to identify a predetermined number of the plurality of historical queries that are semantically related to the received query, wherein a model discovery database stores, for each of a plurality of large language models (LLMs) and for each of the plurality of historical queries, a historical response to the historical query received from the LLM, associated historical metadata, and a quality rank that ranks the LLM from among the plurality of LLMs for the historical query;
determine, for each of the plurality of LLMs, a score for each of a plurality of predetermined metrics based on the quality rank of the LLM and the associated historical metadata in the model discovery database for the identified predetermined number of the historical queries;
determine, for each of the plurality of LLMs, an overall score of the LLM based on the determined scores for the plurality of predetermined metrics; and
transmit, to a user interface of a client device, a ranked list of the plurality of LLMs based on the overall scores.

2. The system of claim 1, wherein the instructions further cause the system to:
input the received query to each of the plurality of LLMs to generate a corresponding sample response to the query;
wherein the ranked list of the plurality of LLMs includes, for each LLM, the determined score for one or more of the plurality of predetermined metrics and the corresponding sample response generated by the LLM.

3. The system of claim 1, wherein the instructions further cause the system to:
receive, from the user interface of the client device, a selection of one or more of the LLMs from the ranked list; and
automatically configure a model serving endpoint based on the received selection.

4. The system of claim 3, wherein the instructions further cause the system to:
in response to determining that the received selection includes a selection of two or more of the LLMs, automatically determine a traffic routing weight for each of the two or more LLMs based on their respective overall scores.

5. The system of claim 4, wherein a traffic routing weight of a first LLM having a first overall score is higher than a traffic routing weight of a second LLM having a second overall score, the first overall score being higher than the second overall score.

6. The system of claim 1, wherein the associated historical metadata stored in the model discovery database for each pair of a historical query and an LLM includes an execution duration of the historical query, prompt tokens of the historical query, output tokens of the historical response, the historical response, and a cost of the historical query, the cost being determined based on the prompt tokens and the output tokens.

7. The system of claim 1, wherein the quality rank of the LLM stored in the model discovery database for each pair of a historical query and an LLM is based on a comparison between the historical response to the historical query and a ground-truth response to the historical query output from a ground-truth model.

8. The system of claim 1, wherein the instructions that cause the system to determine, for each of the plurality of LLMs, the overall score of the LLM comprise instructions that cause the system to, for each of the plurality of LLMs:
normalize scores of each of the predetermined metrics based on the quality ranks and the associated historical metadata in the model discovery database for the predetermined number of the historical queries;
weight the normalized scores of each of the predetermined metrics based on user specified sensitivity values for one or more of the predetermined metrics; and
determine the overall score of the LLM based on the weighted scores of each of the predetermined metrics.

9. The system of claim 1, wherein the predetermined metrics include cost, latency, and rank.

10. A computer-implemented method, comprising:
receiving a query from a user;
generating a vector embedding of the query;
performing a semantic search between the vector embedding of the query and vector embeddings of each of a plurality of historical queries to identify a predetermined number of the plurality of historical queries that semantically best match the received query, wherein a model discovery database stores, for each of a plurality of large language models (LLMs) and for each of the plurality of historical queries, a historical response to the historical query received from the LLM, associated historical metadata, and a quality rank that ranks the LLM from among the plurality of LLMs for the historical query;
determining, for each of the plurality of LLMs, a score for each of a plurality of predetermined metrics based on the quality rank of the LLM and the associated historical metadata in the model discovery database for the identified predetermined number of the historical queries;
determining, for each of the plurality of LLMs, an overall score of the LLM based on the determined scores for the plurality of predetermined metrics; and
transmitting, to a user interface of a client device, a ranked list of the plurality of LLMs based on the overall scores.

11. The computer-implemented method of claim 10, further comprising:
inputting the received query to each of the plurality of LLMs to generate a corresponding sample response to the query;
wherein the ranked list of the plurality of LLMs includes, for each LLM, the determined score for one or more of the plurality of predetermined metrics and the corresponding sample response generated by the LLM.

12. The computer-implemented method of claim 10, further comprising:
receiving, from the user interface of the client device, a selection of one or more of the LLMs from the ranked list; and
automatically configuring a model serving endpoint based on the received selection.

13. The computer-implemented method of claim 12, further comprising:
in response to determining that the received selection includes a selection of two or more of the LLMs, automatically determining a traffic routing weight for each of the two or more LLMs based on their respective overall scores.

14. The computer-implemented method of claim 10, wherein the associated historical metadata stored in the model discovery database for each pair of a historical query and an LLM includes an execution duration of the historical query, prompt tokens of the historical query, output tokens of the historical response, the historical response, and a cost of the historical query, the cost being determined based on the prompt tokens and the output tokens.

15. The computer-implemented method of claim 10, wherein the quality rank of the LLM stored in the model discovery database for each pair of a historical query and an LLM is based on a comparison between the historical response to the historical query and a ground-truth response to the historical query output from a ground-truth model.

16. The computer-implemented method of claim 10, wherein determining, for each of the plurality of LLMs, the overall score of the LLM comprises, for each of the plurality of LLMs:
normalizing scores of each of the predetermined metrics based on the quality ranks and the associated historical metadata in the model discovery database for the predetermined number of the historical queries;
weighting the normalized scores of each of the predetermined metrics based on user specified sensitivity values for one or more of the predetermined metrics; and
determining the overall score of the LLM based on the weighted scores of each of the predetermined metrics.

17. A non-transitory computer readable storage medium comprising stored program code, the program code comprising instructions, the instructions when executed by one or more computer processor of a computing system causes the computing system to:
receive a query from a user;
generate a vector embedding of the query;
perform a semantic search between the vector embedding of the query and vector embeddings of each of a plurality of historical queries to identify a predetermined number of the plurality of historical queries that semantically best match the received query, wherein a model discovery database stores, for each of a plurality of large language models (LLMs) and for each of the plurality of historical queries, a historical response to the historical query received from the LLM, associated historical metadata, and a quality rank that ranks the LLM from among the plurality of LLMs for the historical query;
determine, for each of the plurality of LLMs, a score for each of a plurality of predetermined metrics based on the quality rank of the LLM and the associated historical metadata in the model discovery database for the identified predetermined number of the historical queries;
determine, for each of the plurality of LLMs, an overall score of the LLM based on the determined scores for the plurality of predetermined metrics; and
transmit, to a user interface of a client device, a ranked list of the plurality of LLMs based on the overall scores.

18. The non-transitory computer readable storage medium of claim 17, wherein the instructions further cause the computing system to:
input the received query to each of the plurality of LLMs to generate a corresponding sample response to the query;
wherein the ranked list of the plurality of LLMs includes, for each LLM, the determined score for one or more of the plurality of predetermined metrics and the corresponding sample response generated by the LLM.

19. The non-transitory computer readable storage medium of claim 17, wherein the instructions further cause the computing system to:
receive, from the user interface of the client device, a selection of one or more of the LLMs from the ranked list; and
automatically configure a model serving endpoint based on the received selection.

20. The non-transitory computer readable storage medium of claim 19, wherein the instructions further cause the computing system to:
in response to determining that the received selection includes a selection of two or more of the LLMs, automatically determine a traffic routing weight for each of the two or more LLMs based on their respective overall scores.
